(19) United States
(12) Patent Application Publication
(10) Pub. No.: US 2004/0158395 A1
(43) Pub. Date: Aug. 12, 2004

(54) Navigation system and program of route search method

(75) Inventors: Kunihiro Yamada, Okazaki-shi (JP); Satoshi Ogawa, Okazaki-shi (JP)

Correspondence Address: OLIFF & BERRIDGE, PLC, P.O. BOX 19928, ALEXANDRIA, VA, 22320, US

(73) Assignee: AISIN AW CO., LTD., Anjo-shi (JP)

(21) Appl. No.: 10/740,849

(22) Filed: Dec. 22, 2003

(30) Foreign Application Priority Data
Dec. 26, 2002 (JP) 2002-378402

(51) Int. Cl. G01C 21/34

(52) U.S. Cl. 701/202; 701/209; 340/995.19

(57) ABSTRACT

A navigation system has an information acquisition processing unit for acquiring search data including network data of networks formed for individual transportation methods, a search processing unit for searching acquired search data for routes based on the network data beginning with a network of a highest priority, and a route connection processing unit for connecting the routes found as a result of the search. Since the routes of all the transportation measures are not searched in each network and only routes of a transportation method corresponding to a network are searched, it becomes easier to search for routes in route search processing.

### BACKGROUND OF THE INVENTION

1. Field of Invention

This invention relates to a navigation system, a navigation system program, and a program storage medium of a method of route searching.

2. Description of Related Art

Conventionally, a navigation device searches for routes from a place of departure to a destination using various methods of transportation, such as private vehicles, public transportation facilities, and walking, on the basis of route network data including road data, line data and sidewalk data. (See, for example, Unexamined Japanese Patent Application JP-A-2001-227973.)

FIG. 2 is a schematic view representing an operation of route search processing by such a conventional navigation device.

In FIG. 2, Ps represents a place of departure, such as user's home, Pg represents a destination, and Stl, St2 represent stations. In the conventional navigation device, an operator inputs a place of departure Ps and a destination Pg, a CPU reads route network data from a data recording unit, then searches for a route in accordance with the route network data, and displays the route found as a result of the search as a candidate route on a display unit. Therefore, the operator can select a desired one of candidate routes displayed on the display unit.

However, in the conventional navigation device, since road data, line data and sidewalk data constituting the route network data exist in a mixed manner in a monistic network and are recorded in the data recording unit, the CPU regards all the roads, lines (routes) and sidewalks as search objects when searching for a route.

For example, in the case of searching for a route with a place of departure Ps as a start point, if there are three routes as search objects with respect to roads, three routes as search objects with respect to lines, and three routes as search objects with respect to sidewalks on the network, nine routes are regarded as search objects.

Thus, in order to narrow down the number of possible search routes, the CPU first selects one of a method transportation, such as private vehicles, public transportation and walking, and then performs a preferential search while reducing the search cost of the selected transportation method to be lower than the search costs of the other transportation methods, and repeats this search for each transportation method. Therefore, as the search is performed three times for each of the nine routes, the search process is performed 27 times in total. The burden on the CPU to narrow down the search routes is extremely heavy, making it difficult to search for a route. This burden is particularly significant in portable navigation devices, since the CPU has a lower processing capability, making it very difficult to search for a route using such a device.

### SUMMARY OF THE INVENTION

It is an object of this invention to provide a navigation system and a program for route searching that solves the problems of conventional navigation devices and enables easy route searching using various methods of transportation as one search criterion.

A navigation system according to this invention has an information acquisition processing unit for acquiring search data including network data of networks formed for individual methods of transportation, a search processing unit for searching acquired search data for routes based on the network data beginning with a network of a highest priority, and a route connection processing unit for connecting the routes found as a result of the search.

In an exemplary embodiment of the navigation system according to this invention, each of the network data includes layer data of a plurality of hierarchical layers from a highest layer to a lowest layer. The search processing unit searches for a route on each layer.

In an exemplary embodiment of the navigation system according to this invention, the layer data on a higher layer is formed by search data of a broader range and the layer data on a lower layer is formed by search data of a narrower range.

In an exemplary embodiment of the navigation system according to this invention, the priority of the networks is set in advance.

In an exemplary embodiment of the navigation system according to this invention, the priority of the networks can be changed by an operator.

In an exemplary embodiment of the navigation system according to this invention, a network data acquisition processing unit for reading network data of networks formed for each individual method of transportation, beginning with a network of the highest priority, a search processing unit for searching for routes on each network on the basis of the network data, a route connection processing unit for connecting the routes found as a result of the search, and a route guide data transmission processing unit for transmitting route data of the connected routes to a terminal device is provided.

A program and a program storage medium for a method of route searching according to this invention instructs a computer to function as an information acquisition processing unit for acquiring search data, including network data of networks formed for individual methods of transportation, a search processing unit for searching for routes based on the network data in order from a network of the highest priority, of the acquired search data, and a route connection processing unit for connecting routes found as a result of the search.

As described above, according to this invention, the routes of all the methods of transportation in each network are not searched. Rather, only the routes of a transportation method corresponding to a network are searched. Therefore, it becomes easier to search for routes in the route search processing.

### BRIEF DESCRIPTION OF THE DRAWINGS

FIG. 1 is a functional block diagram showing a navigation system, according to an exemplary embodiment of this invention;

FIG. 2 is a schematic view representing an operation of route search processing by a conventional navigation device;

FIG. 3 is a block diagram showing the navigation system, according to an exemplary embodiment of this invention;

FIG. 4 is a block diagram showing a PDA, according to an exemplary embodiment of this invention;

FIG. 5 is a main flowchart showing an operation of an information display system, according to an exemplary embodiment of this invention;

FIG. 6 is a view showing a data structure of a data management frame, according to an exemplary embodiment of this invention;

FIG. 7 is a view showing an exemplary data structure of a transportation facility network, according to an exemplary embodiment of this invention;

FIG. 8 is a view showing an exemplary data structure of a walking/taxi network, according to an exemplary embodiment of this invention;

FIG. 9 is a view showing an exemplary data structure of a vehicle network, according to an exemplary embodiment of this invention;

FIG. 10 is a flowchart showing a subroutine of route search processing, according to an exemplary embodiment of this invention;

FIG. 11 is a first schematic representation of an operation of route search processing, according to an exemplary embodiment of this invention;

FIG. 12 is a second schematic representation of the operation of route search processing, according to an exemplary embodiment of this invention; and

FIG. 13 is a third schematic representation of the operation of route search processing, according to an exemplary embodiment of this invention.

### DETAILED DESCRIPTION OF PREFERRED EMBODIMENTS

Hereinafter, an exemplary embodiment of this invention will be described in detail with reference to the drawings.

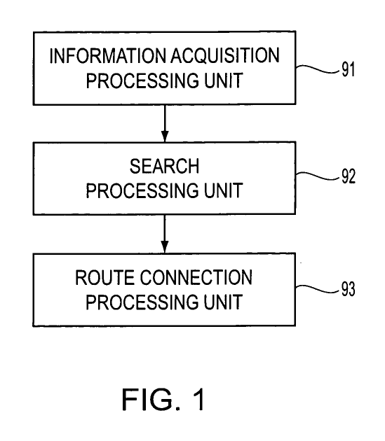

FIG. 1 is a functional block diagram showing a navigation system, according to an exemplary embodiment of this invention.

FIG. 1, shows an information acquisition processing unit 91 for acquiring search data, including network data of networks formed for individual transportation methods, a search processing unit 92 for searching for routes based on the network data beginning with a network of a highest priority of the acquired search data, and a route connection processing unit 93 for connecting the routes found as a result of the search

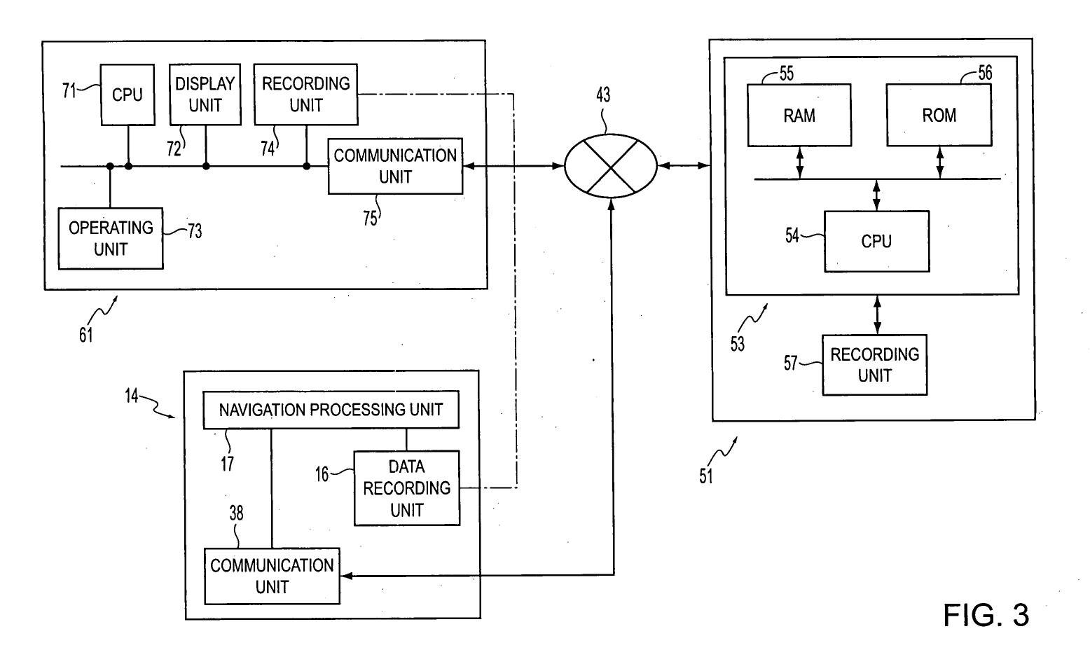

The navigation system will now be described with reference to FIG. 3 which shows a block diagram of the navigation system, according to an exemplary embodiment of this invention.

FIG. 3, shows a personal digital assistant (PDA) 14 as a mobile terminal, an information center 51 as an information provider, and a personal computer 61 as a user terminal. The PDA 14, the personal computer 61, and the information center 51, are connected to each other via a network 43, thus constituting the navigation system. In this exemplary embodiment, the PDA 14 and the personal computer 61 constitute terminal devices. The PDA 14 has a navigation processing unit 17, a data recording unit 16, and a communication unit 38.

In the exemplary embodiment, the personal computer 61 has a CPU 71 as an arithmetic unit and control unit, a display unit 72 as a notification unit for notifying an operator of various information, an operating unit 73, a recording unit 74, and a communication unit 75. While the CPU 71 is used as the arithmetic unit and control unit in this exemplary embodiment, an MPU, or the like, may be used instead of the CPU 71. In addition to the display unit 72 as the notification unit, an audio output unit for notifying the operator of information by voice and/or sound can be provided in the personal computer 61.

As the display unit 72, a display, such as a CRT display, liquid crystal display, plasma display or other known or later developed display can be used. As the operating unit 73, a keyboard, mouse, bar-code reader, light pen, remote control unit for remote operation, joystick, or the like, can be used. Moreover, a touch panel formed on the display can also be used as the operating unit 73. As the touch panel, an operating unit region including various keys, switches, buttons, and the like, is formed on the display. By operating the operating unit, the operator can make a predetermined input.

In the recording unit 74, an internal memory, such as a RAM, ROM or flash memory (not shown), is provided, and an external memory (not shown) such as a hard disk, memory card, magnetic tape, magnetic drum, CD-ROM, CD-R, MD, DVD, optical disc, MO, IC card or optical card, may be selectively provided. In the recording unit 74, a reading device for reading data recorded in the external memory and a writing device for recording data into the external memory are provided. The hard disk constitutes a first recording medium, and the memory card constitutes a second recording medium.

In this exemplary embodiment, the personal computer 61 is used as the user terminal, and the PDA 14 is used as the mobile terminal. However, instead of the personal computer 61 and the PDA 14, other terminal devices that can be connected to the network 43 and can perform bi-directional communication, may be used. For example, an on-vehicle device, such as a navigation device, electronic notebook, portable telephone, portable terminal, video telephone and game machine can also be used as the user terminal and/or mobile terminal.

In the exemplary embodiment, the information center 51 has a server 53, and a recording unit 57 connected to the server 53. The server 53 has a CPU 54, a RAM 55 and a ROM 56. The recording unit 57 may include various databases, such as a map database in which map data for displaying a map is recorded, a facility database in which facility data related to various facilities is recorded, a transportation facility database in which transportation facility data related to public transportation facilities is recorded, and a search database in which search data for searching for a route is recorded. The map data, facility data, transportation facility data and search data constitute navigation data.

In an exemplary embodiment, the map database includes databases, such as a road database, an intersection database and a node database. In the road database, road data representing information regarding roads, formed by strings of road links, is recorded. In the intersection database, intersection data representing information regarding intersections is recorded. In the node database, node data representing information regarding nodes set along each road is recorded.

As the road data, data representing, for example, widths, slopes, cants, banks, states of road surfaces, the number of lanes in the roads, points where the number of lanes decreases, points where the width is narrowed, railroad crossings, and the like, are recorded. With respect to curves, for example, data representing radii of curvature, intersections, T-junctions, entrances and exits of the curves, and the like, are recorded. With respect to road attributes, data representing downhill roads, uphill roads, and the like, are recorded. With respect to road types, for example, data representing general roads, including national highways, prefectural highways, minor roads, as well as expressway/toll roads including expressways, city expressways, toll roads, and the like, are recorded. Moreover, for expressways/toll roads, data representing entry and exit ramps, tollgates, and the like, are recorded.

As the node data, data representing, for example, road junctions (including intersections, T-junctions, and the like), coordinates (positions) of nodes set at every predetermined distance in accordance with the radius of curvature of each road, inter-node links connecting nodes, altitudes of the nodes, and the like, are recorded.

As the facility data, data representing facilities, such as hotels, gas stations, parking spaces, tourist facilities, and the like, in each region are recorded.

In the exemplary embodiment, the transportation facility database includes databases, such as a railroad database in which railroad data representing information of railroads is recorded, a subway database in which subway data representing information of subways is recorded, a bus database in which bus data representing information of buses is recorded, an airplane database in which airplane data representing information of airplanes is recorded, a ship database in which ship data representing information of ships is recorded, and a transportation facility transfer database in which transfer data representing information of transfer between different transportation facilities is recorded.

The railroad database may include, for example, a line database in which line data representing, information of each line is recorded, a station database in which station data representing information of each station is recorded, a train database in which train data representing information of each train is recorded, a transfer database in which transfer data representing information of transfer is recorded, a timetable database in which timetable data representing information of timetables is recorded, and a fare database in which fare data representing information of fares is recorded.

In the line database, for example, data such as the line number, the name of a line, the type of a line, such as a conventional line, long-distance line or super express line, the distance and required time between stations on the line, and line node data representing the shape and dimension of the line, are recorded as the line data. In order to draw a line connecting stations, data such as junctions (including stations and the like) on the line, coordinates (positions) of line nodes set at a predetermined distance on each line in accordance with the radius of curvature, or the like, line links connecting the line nodes, and altitudes of the line nodes are recorded as the line node data. The data representing the line links includes, for example, line link numbers, line link length, the traveling time representing time required for traveling the line links, and the like.

In the station database, for example, data such as the station number, and name of the station are recorded, for example. In the train database, data such as the train number, the name of train, the type of each train such as limited express, express, semi-express or local train, and the number of cars of each train, are recorded.

In the transfer database, for example, data such as the station number of an interline transfer station, a combination of two lines in such a transfer, the station number of a station where transfer (connection) between different trains on the same line is possible, i.e., inter-train transfer station number, a combination of two trains in such a transfer, the time required for a transfer, and the like, are recorded.

In the timetable database, for example, data such as the departure times at each station, the arrival times at each station, the duration of stop times at each station, and platform numbers representing departure and arrival platforms, of each train, are recorded. In the fare database, for example, data such as fares between stations, fares by train type, i.e. limited express, express, semi-express or the like, reserved seat fares, fares by car type of special car, sleeping car, or the like, and fares added or subtracted in the case of a transfer are recorded.

The subway database includes, for example, a line database in which line data representing information of each line is recorded, a station database in which station data representing information of each station is recorded, a subway train database in which subway train data representing information of each subway train is recorded, a transfer database in which transfer data representing information of transfer is recorded, a timetable database in which timetable data representing information of timetables is recorded, and a fare database in which fare data representing information of fares is recorded.

In the line database, data such as a line number, the name of lines, the distance and required time between stations on the line, and line node data representing the shape and dimension of the line are recorded.

In the station database, data such as the station number and the name of the station are recorded. In the subway train database, data such as the subway train number, the name of a subway train, the train type such as a fast or a local train of each subway train, and the number of cars of each subway train are recorded. In the transfer database, data such as interline transfer station number, a combination of two lines in such a transfer, the station number of a station where transfer (connection) between different subway trains on the same line is possible, i.e., inter-subway train transfer station number, a combination of two subway trains in such a transfer, and the required transfer time are recorded.

In the timetable database, data such as departure times at each station, arrival times at each station, the duration of stop times at each station, and platform numbers representing departure and arrival platforms of each subway train, are recorded. In the fare database, data such as fares between stations and fares added or subtracted in the case of a transfer are recorded.

The bus database includes, for example, a line database in which line data representing information of each line is recorded, a bus stop database in which bus stop data representing information of each bus stop is recorded, a bus database in which bus data representing information of each bus is recorded, a transfer database in which transfer data representing information of transfer is recorded, a timetable database in which timetable data representing information of timetables is recorded, and a fare database in which fare data representing information of fares is recorded.

In the line database, data such as line (route) number, the name of a line, the distance and required time between bus stops on the line, and line node data representing the shape and dimension of the line are recorded. As the line node data, data such as junctions (including intersections, T-junctions, bus stops, and the like) on each line, coordinates (positions) of line nodes, line links and altitudes of line nodes are recorded.

In the bus stop database, data such as the bus stop number, and the name of a bus stop are recorded. In the transfer database, the number of a bus stop where transfer (connection) between different buses on the same line is possible, the number of a bus stop where transfer between different lines is possible, a combination of two lines in such transfers, and the required transfer times are recorded. In the timetable database, data such as departure times at each bus stop and arrival times at each bus stop, of each bus, are recorded. In the fare database, data such as fares between bus stops and fares added or subtracted in the case of a transfer are recorded.

The airplane database includes, for example, a line database in which line data representing information of each line (route) is recorded, an airport database in which airport data representing information of each airport is recorded, a flight database in which flight data representing information of each flight is recorded, a transfer database in which transfer data representing information of transfer (connection) is recorded, a timetable database in which timetable data representing information of timetables is recorded, and a fare database in which fare data representing information of fares is recorded.

In the line database, data such as a line number, the name of line, the type of line such as a domestic or an international line, the distance and required time between airports on the line, and line node data representing the shape and dimension of each line are recorded. The data for drawing lines connecting airports is returned from the line node data.

In the airport database, data such as the airport number, and the name of the airport are recorded. In the flight database, data such as the flight name representing the number of each flight (name of flight) and the aircraft type are recorded. In the transfer database, data such as the number of an airport where transferring between different lines is possible, i.e., interline transfer airport number, a combination of two lines in such a transfer, and the required transfer time are recorded.

In the timetable database, data such as the boarding time at each airport, the departure time at each airport, the arrival time at each airport, and the gate numbers representing departure and arrival gates of each flight, are recorded. In the fare database, data such as fares for first class, business class seats, economy class, or the like, and discount rates between airports are recorded.

The ship database includes, for example, a line database in which line data representing information of each line (route) is recorded, a port database in which port data representing information of each port is recorded, a liner database in which liner (ship) data representing information of each liner is recorded, a transfer database in which transfer data representing information of transfer is recorded, a timetable database in which timetable data representing information of timetables is recorded, and a fare database in which fare data representing fare information is recorded.

In the line database, data such as a line number, the name of line, the type of line such as a domestic or an international route, the distance and required time between ports on the line, and line node data representing the shape and dimension of each line are recorded. As the line node data, data for drawing lines connecting ports is recorded.

In the port database, data such as the port number, and the name of the port are recorded. In the port database, data such as the liner name representing the name and/or number of liner and the type of ship are recorded. In the transfer database, data such as the number of a port where transferring between different lines is possible, i.e., interline transfer port number, a combination of two lines in such a transfer, and the required transfer time are recorded.

In the timetable database, data such as the departure time at each port, the arrival time at each port, and the gate numbers representing the departure and arrival gates, of each liner, are recorded. In the fare database, data such as cabin fares for the type of suite, including special class, first class, second class, sleeper, or the like, is recorded.

In the transportation facility transfer database, data such as the time required for transfer between different transportation facilities, such as railroad, subway, bus, airplane, ship and the like, is recorded.

In the search database, the road data, intersection data, facility data, transportation facility data, and the like, are recorded as search data for searching a route. The search data is classified into a plurality of hierarchical layers ranging from an uppermost layer to a lowermost layer, constituting layer data. In this case, layer data on a higher layer is formed by search data of a broader range and layer data on a lower layer is formed by search data of a narrower range.

In the recording unit 57, audio output data for outputting predetermined information in the PDA 14 with voice or sound is also recorded.

The information center 51 can receive traffic information, including, for example, information such as traffic congestion information, traffic control information, parking space information, traffic accident information and the amount of congestion in service areas. Such information may be transmitted from a traffic information transmission center, i.e., traffic information provider, Vehicle Information and Communication System (VICSTM) center. Moreover, the information center 51 can receive transportation information, including information such as of the availability services and availability of seating with respect to railroads, subways, buses, airplanes, ships, and the like, transmitted from the companies operating the transportation facilities. The information center 51 may also receive general information, such as news and weather forecast, transmitted from various broadcasting stations.

The information center 51 sends the traffic and transportation information, as well as the general information, to the PDA 14 and the personal computer 61 via the network 43, and/or records the information at the recording unit 57 for processing. For this purpose, a statistical database is provided in the recording unit 57. Past traffic, transportation, and general information is recorded in time series as statistical data. Predetermined processing is performed on the information, and the processed data of the information are recorded as navigation data. In processing the traffic, transportation, and general information, the information is referred to, when necessary.

In various exemplary embodiments of this invention, the information center 51 may be any of an individual person, corporation, organization, local government, governmental organization, and the like. The information center 51 prepares the navigation data, or purchases the navigation data, from another information provider, and supplies the navigation data, to the PDA 14 and the personal computer 61.

In various exemplary embodiments of this invention, the network 43 may be any of a LAN (local area network), WAN (wide area network), wireless LAN, portable telephone network, telephone network, public communication network, leased communication networks, and the Internet. As the network 43, communication measures using CS broadcasting and BS broadcasting based on broadcasting satellites, ground-wave digital television broadcasting, FM multiplex broadcasting, and the like, can also be used. Moreover, communication measures such as the Electronic Toll Collection System (ETC) used in the Intelligent Transport System (ITS) and the Dedicated Short Range Communication System (DSRC) can also be used as the network 43.

Each of the navigation processing unit 17, the personal computer 61, and the server 53, may function individually, or a combination of two or more of them may functions as a computer on the basis of predetermined programs and data.

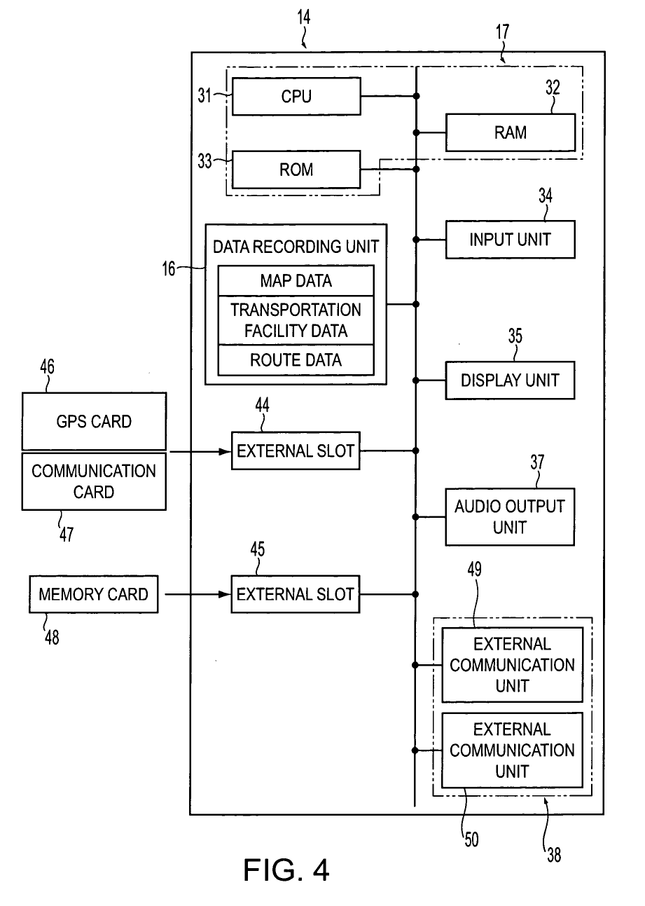

The PDA 14 will now be described with reference to FIG. 4.

FIG. 4 is a block diagram showing a PDA, according to an exemplary embodiment of this invention.

In FIG. 4, the PDA 14 includes a navigation processing unit 17 for performing various arithmetic processes such as navigation processing on the basis of inputted information. The PDA 14 also includes a data recording unit 16 in which predetermined navigation data and/or route data are recorded, an input unit 34 as an operating unit, a display unit 35 as a first notification unit, an audio output unit 37 as a second notification unit, a communication unit 38, external slots 44, 45 as first and second interfaces, and so on. The data recording unit 16 may also include a flash memory provided as an internal memory.

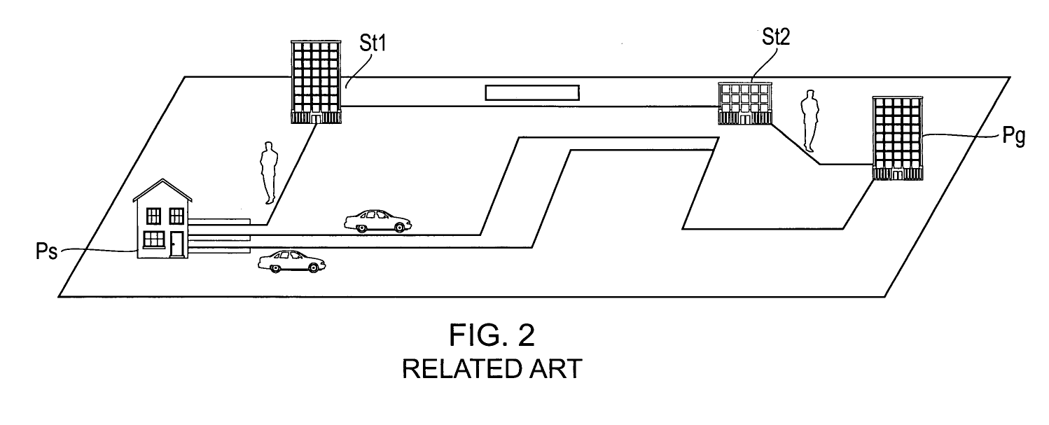

When a global positioning system (GPS) card 46 is externally attached to the PDA 14 at the external slot 44, the current position of the PDA 14 can be detected. When a communication card 47 is externally attached to the PDA 14 at the external slot 44, the network 43 (FIG. 2) and the PDA 14 can be connected with each other via the communication card 47. When a memory card 48 is externally attached at the external slot 45, various programs and data may be recorded on the memory card 48.

In an exemplary embodiment of this invention, a GPS sensor (not shown) may be provided within the GPS card 46. The GPS sensor receives electronic waves generated by artificial satellites and thus detects the current position, absolute time, and the like, of the unit on the earth.

The navigation processing unit 17 includes a CPU 31 as an arithmetic unit and control unit for performing overall control of the PDA 14. Internal memories such as, a RAM 32 used as a working memory when the CPU 31 performs various arithmetic processes, and a ROM 33 in which control programs and various programs for performing route searches, route guiding and the like, may be used. The input unit 34, display unit 35, audio input unit 36, audio output unit 37 and communication unit 38 are connected to the navigation processing unit 17. Semiconductor memories, magnetic cores, and the like, may be used as the RAM 32, ROM 33 and the data recording unit 16. An MPU, or the like, can be used as the arithmetic unit and control unit, instead of the CPU 31.

While a flash memory is used for the data recording unit 16 in this exemplary embodiment, a hard disk (not shown) may be used as an external memory. In this case, a reading device for reading data recorded in the hard disk and a writing device for recording data to the hard disk are provided. Alternatively, a flexible disk, CD-ROM, CD-R, MD, DVD, optical disc, MO, IC card, optical card, memory card, or the like, may be provided as an external memory, instead of the hard disk.

In this exemplary embodiment, various programs are recorded in the ROM 33 and various data are recorded in the data recording unit 16. However, the programs and data may also be recorded to the same external memory. In this case, for example, the programs and data can be read from the external memory and written to the data recording unit 16. Therefore, it is possible to update the programs and data by replacing the external memory.

The input unit 34 is adapted for correcting the current position, inputting a place of departure and a destination, and operating the communication unit 38. The input unit 34 includes operating switches (not shown) such as, for example, various keys, switches and buttons, and a stylus switch. The input unit 34 may also include an operating unit region including various keys, switches and buttons displayed as an image on a screen formed on a display (not shown) of the display unit 35, and the user can input commands by touching the operating unit region with a light pen (not shown).

In various exemplary embodiments of this invention, the input unit 34 may include, a keyboard, mouse, bar-code reader, remote control unit for remote operation, light pen, joystick or the like. A microphone, or the like, for inputting necessary information by voice and sound may also be used.

The display unit 35 may include, for example, a display such as a liquid crystal display or plasma display. The display may be used to show various screens, such as, an operation guide, operation menu, key guide, search route from a place of departure to a destination, guide information along the search route, FM multiplex broadcasting program, and the like.

In an exemplary embodiment of this invention, the audio output unit 37 may include a voice synthesizer and speaker (not shown) so that the search route, guide information, and the like, are outputted from the audio output unit 37. In addition to voice and sound synthesized by the voice synthesizer, various sounds, various guide information recorded in advance on a tape, memory, or the like, can be outputted.

The communication unit 38 may include an external communication unit 49 for radio communication for connecting the PDA 14 with a personal computer 61 via a wireless LAN, or connecting the PDA 14 with the information center 51 via the network 43. The communication unit 38 may also include an external communication unit 50 for wired communication for connecting the PDA 14 with a personal computer 61 via a serial connector, cable or the like. The external communication unit 49 enables reception of traffic and transportation information, including information such as traffic congestion information, traffic control information, parking space information, traffic accident information and the amount of congestion in service areas, transmitted from a VICSTM center, the information center 51, or the like. News information, weather forecasts, and the like, may also be received via the unit as FM multiplex information.

If the data recording unit 16 has sufficient storage capacity, various databases can be formed in the data recording unit 16 and navigation data can be recorded in the databases. However, if the data recording unit 16 has insufficient storage capacity, the operator can may use the input unit 34 to download and acquire necessary navigation data, such as map data, transportation facility data and search data. In this case, as the operator selects and inputs a predetermined area for which the operator needs map data, transportation facility data, search data, or the like, a data request processing unit (not shown) of the CPU 31 performs data request processing and transmits a predetermined request signal to the information center 51.

As the request signal is received by the information center 51, the information acquisition processing unit 91 (FIG. 1) of the CPU 54 performs information acquisition processing and acquires the requested map data, transportation facility data, search data, and the like, from the recording unit 57. A data transmission processing unit (not shown) of the CPU 54 performs data transmission processing and sends the acquired data to the PDA 14. When the acquired data is transmitted, a recording processing unit (not shown) of the CPU 31 in the PDA 14 performs recording processing and downloads and records the acquired data to the data recording unit 16.

Therefore, a predetermined map can be displayed on the display unit 35 of the PDA 14 on the basis of the acquired data. The displayed screen may be used by the operator to search for a route from a place of departure to a destination on the basis of the search data, and the search route displayed.

In an exemplary embodiment of this invention, it is also possible to operate the operating unit 73 of the personal computer 61 to acquire map data, transportation facility data, search data, and the like, from the information center 51, record the data to the recording unit 74 of the computer 61 and the data recording unit 16 of the PDA 14 (FIG. 3).

In this case, for example, as the operator operates the operating unit 73 of the personal computer 61 and selects and inputs a predetermined area for which the operator wants to acquire map data, transportation facility data, search data, and the like, a data request processing unit (not shown) of the CPU 71 performs data request processing and transmits a predetermined request signal to the information center 51.

As the request signal is received by the information center 51, the information acquisition processing unit 91 acquires the appropriate data of the selected area from the recording unit 57. The data transmission processing unit of the CPU 54 performs data transmission processing and transmits the acquired data to the personal computer 61.

When the acquired data is transmitted, a recording processing unit (not shown) of the CPU 71 in the personal computer 61 performs recording processing and downloads the acquired data to the hard disk of the recording unit 74. The recording processing unit may also copy and record the downloaded data to the memory card 48 if a memory card 48 has been set into the recording unit 74.

If an operator has set the memory card 48 into the external slot 45 of the PDA 14, the recording processing unit of the CPU 31 performs recording processing and copies the data to the data recording unit 16.

Moreover, in the PDA 14 of the above-described exemplary embodiment, since the current position can be detected by the GPS sensor, the current position can be displayed on the search route shown on the display and route guiding can be made along the search route.

When searching for a route, a search mode can be selected. Search modes are classified into different modes to search roads as search objects for a route, a mode to search methods of transportation, such as railroads, subways, buses, airplanes and ships as search objects for a route, a mode to search lines of a designated transportation method as search objects for a route, a mode to search roads and lines of transportation methods as search objects for a route, a mode to search roads and lines of a designated transportation method as search objects for a route, and so on.

Moreover, depending on the search technique, search modes may be classified into a search mode to search for a route connecting a place of departure and a destination in a minimum amount of time, a search mode to search for a route on which one can travel from a place of departure to a destination with a minimum fare, a search mode to search for a route with a minimum number of transfers from a place of departure to a destination, a search mode to search for a route on which one can use a reserved seat from a place of departure to a destination, and so on.

Operation of an information display system will now be described where the navigation system is used as the information display system and the search mode to search roads and lines of transportation facilities as search objects for a route is selected.

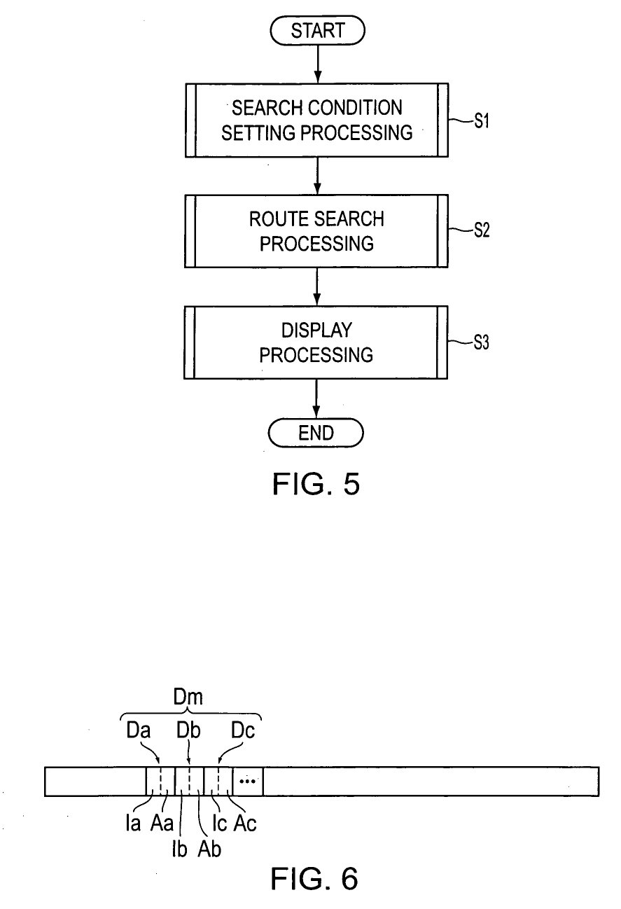

FIG. 5 is a main flowchart showing the operation of the information display system, according to an exemplary embodiment of this invention.

In the PDA 14 (FIG. 3), for example, the operator operates the operating unit 34 to input a route search from a place of departure to a destination and inputs a search mode. A search condition setting processing unit (not shown) of the CPU 31 performs search condition setting processing to set the route search and the search mode as search conditions, and transmits the search conditions to the information center 51 (FIG. 2). The operator can also set the current position as a place of departure and input a route search from the current position to a destination.

As the search conditions are received by the information center 51, the information acquisition processing unit 91 refers to the search database in the recording unit 57, reads search data and acquires the necessary information for searching a route.

A route search processing unit (not shown) of the CPU 54 performs route search processing and searches for a route on the basis of the search data in accordance with the search conditions. As a result, a plurality of search routes meeting the search conditions are found as candidate routes and the candidate routes are outputted. In this case, since the search mode to search roads and lines of transportation facilities as search objects for a route has been selected, each candidate route is one of roads, railroad lines, subway lines, bus lines, airlines, ship lines, and the like, from the place of departure to the destination, or a combination of two or more of these lines.

A route guide data transmission processing unit (not shown) of the CPU 54 performs route guide data transmission processing, and transmits route data representing each candidate route and audio output data, through the audio output unit 37 as route guide data to the PDA 14.

In the PDA 14, as the route guide data is received, a display processing unit (not shown) of the CPU 31 performs display processing to form a candidate route display screen on the display unit 35 and displays a candidate list, including the candidate routes, timetable data, and the like. An audio output processing unit, not shown, of the CPU 31 performs audio output processing and outputs the candidate list by voice and/or sound from the audio output unit 37 in accordance with the audio output data. The display processing unit and the audio output processing unit form a notification processing unit. The notification processing unit performs notification processing and notifies the operator of the candidate routes.

Therefore, the operator can select a desired candidate route from the candidate list. As a search route can be thus acquired, the operator can follow the search route to travel from the place of departure to the destination.

The flowchart shown in FIG. 5 will now be described.

At step S1, the search condition setting processing is performed.

At step S2, the route search processing is performed.

At step S3, the display processing is performed and then the processing ends.

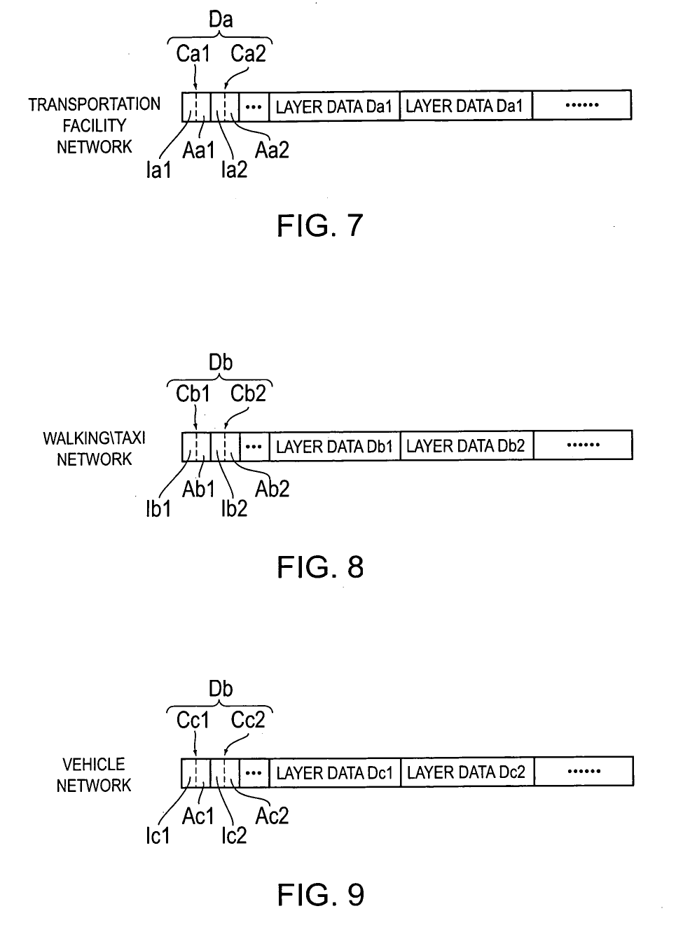

Data structures in the data recording unit 16 will now be described with reference to FIGS. 6-9. FIG. 6 is a view showing a data structure of a data management frame, according to an exemplary embodiment of this invention. FIG. 7 is a view showing an exemplary data structure of a transportation facility network in the exemplary embodiment of this invention. FIG. 8 is a view showing an exemplary data structure of a walking/taxi network in the exemplary embodiment of this invention. FIG. 9 is a view showing an exemplary data structure of a vehicle network in the exemplary embodiment of this invention.

In an exemplary embodiment of this invention, search data is recorded in the data recording unit 16 of the PDA 14 (FIG. 3) in order to perform route search processing. The search data may have, independent networks for methods of transportation, such as public transportation facilities, walking, taxis, other vehicles, and the like. In this embodiment, a method of transportation network for searching lines of transportation methods as search objects, a walking/taxi network for searching roads traveled by walking or taxi as search objects, and a vehicle network for searching roads traveled by vehicle, are provided.

For this purpose, for example, a data management frame as shown in FIG. 6, a frame of the method of transportation network as shown in FIG. 7, a frame of the walking/taxi network as shown in FIG. 8, a frame of the vehicle network as shown in FIG. 9, are formed in the data recording unit 16. The search data is recorded into the frame of each network.

While one network is provided for transportation facilities in this exemplary embodiment, the transportation facilities may also be divided into plurality of transportation methods and independent networks may be provided for railroads, subways, buses, airplanes, ships, and the like. In this case, a frame of a railroad network, a frame of a subway network, a frame of a bus network, a frame of an airplane network, a frame of a ship network, and the like, are formed. The search data is recorded into the frame of each network. Similarly, walking/taxis, other vehicles, and the like, may be divided into a plurality of transportation methods and independent networks may be provided for these transportation methods.

Transportation method management data Dm is recorded at a predetermined part of the data management frame. The transportation method management data Dm, such as management data Da for transportation facilities, management data Db for walking/taxis, management data Dc for vehicles, and the like, are recorded.

In this embodiment, since the transportation method data are collectively managed, the management data Da for the transportation facilities is recorded. However, in the case where the transportation facilities are divided into a plurality of transportation methods as described above, the transportation facility data are divided into railroad data, subway data, bus data, airplane data, ship data, and the like, and these data are managed individually. The management data is recorded for each of these data.

The management data Da, Db, Dc, etc., include transportation method identification (ID) data Ia, Ib, Ic, etc., representing the transportation facility network, walking/taxi network, vehicle network, and the like, and position data Aa, Ab, Ac, etc., representing positions where the network data of the transportation facility network, walking/taxi network, vehicle network, and the like, are recorded, respectively. The position data Aa, Ab, Ac, etc., are offset values from addresses where the position data Aa, Ab, Ac, etc., are recorded to leading addresses where the network data are recorded, respectively, or leading addresses where the individual network data are recorded, respectively.

In the frame of the transportation facility network shown in FIG. 7, the network data of the method of transportation network, of the search data, is recorded. The network data includes the management data Da including management data Ca1, Ca2, etc., and layer data Da1, Da2, etc., constituting uppermost to lowermost hierarchical layers. The management data Ca1, Ca2, etc., includes layer identification (ID) data Ia1, Ia2, etc., representing the layer data Da1, Da2, etc., respectively, and position data Aa1, Aa2, etc., representing positions where the layer data Da1, Da2, etc., are recorded. The position data Aa1, Aa2, etc., are offset values from addresses where the position data Aa1, Aa2, etc., are recorded to leading addresses where the layer data Dal, Da2, etc., are recorded, respectively, or leading addresses where the layer data Da1, Da2, etc., are recorded, respectively.

As described above, the layer data Da1, Da2, etc., constitute uppermost to lowermost hierarchical layers. On a higher layer, the layer data is formed by search data of a broader range that is not subdivided and includes data of major roads, major lines and the like. On a lower layer, the layer data is formed by subdivided search data of a narrower range that includes data of minor roads, minor lines and the like in addition to data of major roads, major lines, and the like.

For example, with respect to the railroad data, uppermost to lowermost layer data made up of line data of super express trains, line data of limited express trains, line data of express trains, line data of local trains, and the like, respectively, are recorded.

Therefore, in the search processing in the transportation facility network, first, in accordance with the layer data Da1 made up of the line data of super express trains on the uppermost layer, a route from a first super express train station representing a predetermined point near a place of departure Ps to a second super express train station representing a predetermined point near a destination Pg, is searched for. Next, in accordance with the layer data Da2 made up of the line data of express trains on the second highest layer, a route from a first station at which an express train stops, representing another predetermined point near the place of departure Ps, to the first super express station, is searched for, and a route from a first station at which an express train stops, representing another predetermined point near the destination Pg, to the second super express station, is searched for. As this search operation is repeated, in accordance with the layer data made up of the line data of local trains on the lowermost layer, a route to a station representing the nearest point from the place of departure Ps and a route to a station representing the nearest point from the destination Pg can be searched for.

Similarly, in the frame of the walking/taxi network shown in FIG. 8, network data of the walking/taxi network is recorded. The network data includes the management data Db including management data Cb1, Cb2, etc., and layer data Db1, Db2, etc., constituting uppermost to lowermost hierarchical layers. The management data Cb1, Cb2, etc., include layer identification (ID) data Ib1, Ib2, etc., representing the layer data Db1, Db2, etc., respectively, and position data Ab1, Ab2, etc., representing positions where the layer data Db1, Db2, etc., are recorded. The position data Ab1, Ab2, etc., are offset values from addresses where the position data Ab1, Ab2, etc., are recorded to leading addresses where the layer data Db1, Db2, etc., are recorded, respectively, or leading addresses where the layer data Db1, Db2, etc., are recorded, respectively.

Also in this case, the layers data Db1, Db2, etc., constitute uppermost to lowermost hierarchical layers. On a higher layer, the layer data is formed by search data of a broader range, while on a lower layer, the layer data is formed by search data of a narrower range. For example, with respect to the road data, uppermost to lowermost layer data made up of road data of national highways, road data of prefectural highways, road data of minor roads, and the like, are recorded.

Therefore, in the search processing in the walking/taxi network, first, in accordance with the layer data Db1 made up of the road data of national highways on the uppermost layer, a route from a first predetermined point near a place of departure Ps to a first predetermined point near a destination Pg is searched for. Next, in accordance with the layer data Db2 made up of the road data of prefectural highways on the second highest layer, a route from a second predetermined point near the place of departure Ps to the first predetermined point near Ps is searched for, and a route from another predetermined point near the destination Pg to the first predetermined point is searched for. As this search operation is repeated, in accordance with the layer data made up of the road data of minor roads on the lowermost layer, a route to the nearest point from the place of departure Ps and a route to the nearest point from the destination Pg can be searched for.

In the frame of the vehicle network shown in FIG. 9, the network data of the vehicle network, is recorded. The network data includes the management data Dc including management data Cc1, Cc2, etc., and layer data Dc1, Dc2, etc., constituting uppermost to lowermost hierarchical layers. The management data Cc1, Cc2, etc., include layer identification (ID) data Ic1, Ic2, etc., representing the layer data Dc1, Dc2, etc., respectively, and position data Ac1, Ac2, etc., representing positions where the layer data Dc1, Dc2, etc., are recorded. The position data Ac1, Ac2, etc., are offset values from addresses where the position data Ac1, Ac2, etc., are recorded to leading addresses where the layer data Dc1, Dc2, etc., are recorded, respectively, or leading addresses where the layer data Dc1, Dc2, etc., are recorded, respectively.

Also in this case, the layers data Dc1, Dc2, etc., constitute uppermost to lowermost hierarchical layers. On a higher layer, the layer data is formed by search data of a broader range, while on a lower layer, the layer data is formed by search data of a narrower range. For example, with respect to the road data, uppermost to lowermost layer data made up of road data of expressways, road data of national highways, road data of prefectural highways, road data of minor roads, and the like, are recorded.

Therefore, in the search processing in the vehicle network, in accordance with the layer data Dc1 comprised of the road data of expressways on the uppermost layer, a route from a first predetermined point near a place of departure Ps to a predetermined point near a destination Pg is searched for. Next, in accordance with the layer data Dc2 comprised of the road data of national highways on the second highest layer, a route from a second predetermined point near the place of departure Ps to the first predetermined point is searched for, and a route from another predetermined point near the destination Pg to the predetermined point near Pg is searched for. As this search operation is repeated, in accordance with the layer data made up of the road data of minor roads on the lowermost layer, a route to the nearest point from the place of departure Ps and a route to the nearest point from the destination Pg can be searched for.

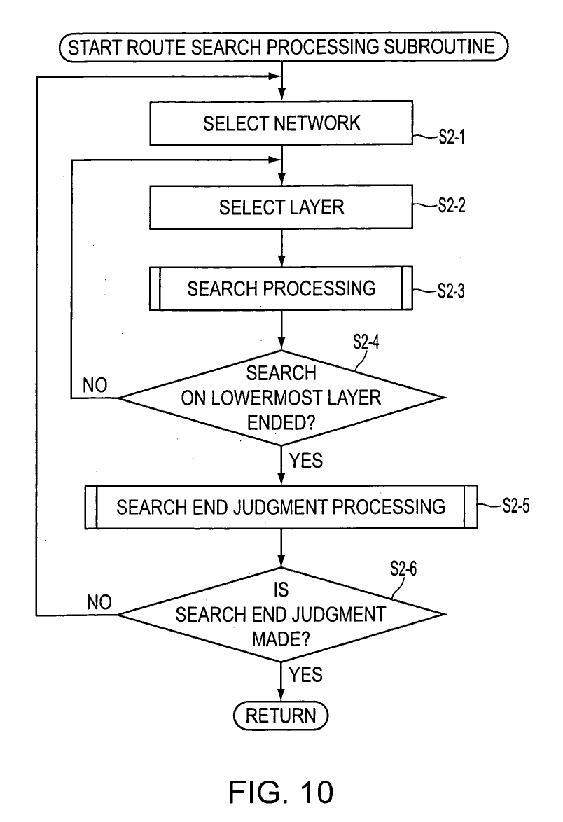

A subroutine of the route search processing of step S2 in FIG. 5 will now be described with reference to FIGS. 10-13.

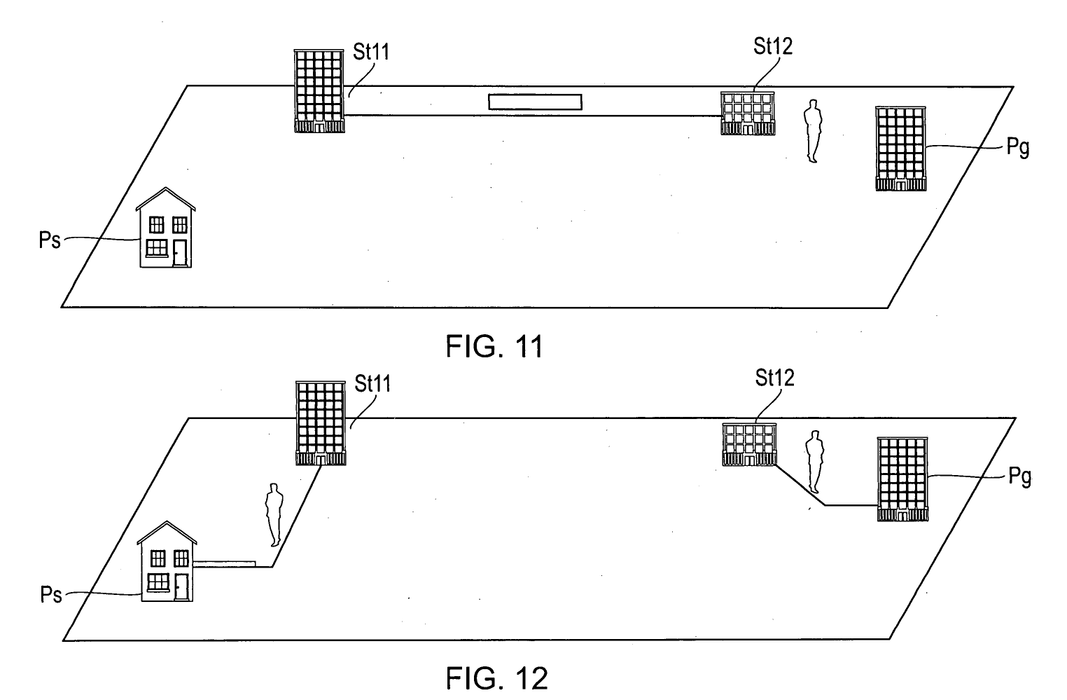

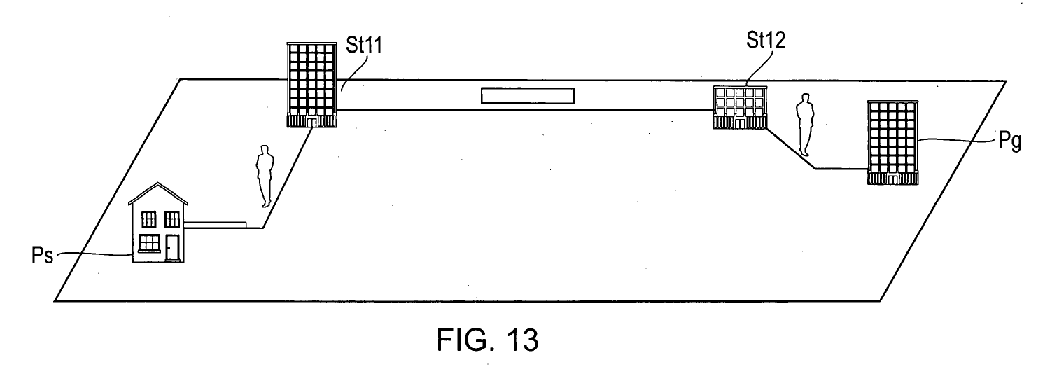

FIG. 10 is a view showing the subroutine of the route search processing, according to an exemplary embodiment of this invention. FIG. 11 is a first schematic view for explaining an operation of the route search processing according to an exemplary embodiment of this invention. FIG. 12 is a second schematic view for explaining the operation of the route search processing according to an exemplary embodiment of this invention. FIG. 13 is a third view for explaining the operation of the route search processing according to an exemplary embodiment of this invention.

In the CPU 54, a network selection processing unit (not shown) of the route search processing unit performs network selection processing to select a network of the highest priority from the recording unit 57 and reads the network data of the selected network of the transportation facility network. Although in this embodiment, the priority is set in advance, in the order of the transportation facility network, walking/taxi network, vehicle network, etc., the operator can operate the input unit 34 to change the priority to each network.

A layer selection processing unit (not shown) of the route search processing unit performs layer selection processing to select the uppermost layer in the transportation facility network and reads the layer data Da1. The search processing unit 92 (FIG. 1) of the route search processing unit performs search processing to search for a route on the basis of the layer data Da1. Then, the layer selection processing unit sequentially selects and reads out the uppermost to lowermost layer data Da1, Da2, etc., and the search processing unit 92 searches for a route on the basis of each of the layer data Da1, Da2, etc. As the layer selection processing and the search processing are repeated on the uppermost to lowermost layers, a search end judgment processing unit (not shown) of the route search processing unit performs search end judgment processing to determine if the search processing in the transportation facility network ended.

In this manner, in the transportation facility network, a route from a station St11, representing the nearest point to a place of departure Ps, to a station St12 representing the nearest point to a destination Pg can be searched for, as shown in FIG. 11.

The network selection processing unit selects a network of the second highest priority, in this embodiment, the walking/taxi network, from the recording unit 57, and reads the network data of the walking/taxi network. The layer selection processing unit sequentially reads the uppermost to lowermost layer data Db1, Db2, etc., and the search processing unit 92 searches for a route on the basis of each of the layer data Db1, Db2, etc. As the layer selection processing and the search processing are repeated on the uppermost to lowermost layers, the search end judgment processing unit determines if the search processing in the walking/taxi network ended.

In this manner, in the walking/taxi network, a route to the station St11, representing the nearest point from the place of departure Ps, and a route to the station St12, representing the nearest point from the destination Pg, can be searched for, as shown in FIG. 12.

When search processing in each network is ended, the route connection processing unit 93 of the route search processing unit performs route connection processing to connect the routes found in the individual networks and outputs a search route from the place of departure Ps to the destination Pg as a candidate route, as shown in FIG. 13.

As described above, a network is formed for each method of transportation and a route is searched for in each network in accordance with the priority. In a network of higher priority, the search is performed on the basis of the search data of a broader range. In a network of lower priority, the search is performed on the basis of search data of a narrower range. Therefore, it is not necessary to search the whole network data of each network as objects of search with respect to all methods of transportation.

For example, if there are three routes as search objects with respect to lines in the transportation facility network, three routes as search objects with respect to roads in the walking/taxi network, and three routes as search objects with respect to roads in the vehicle network, the three routes in the transportation facility network, which is given the highest priority, are first taken as search objects. Then the three routes in the walking/taxi network, which is given the second highest priority, are taken as search objects. Finally, the three routes in the vehicle network, which is given the lowest priority, are taken as search objects. Therefore, as the search is performed only once on the nine routes, processing is performed only nine times in total.

Since a network is formed for each transportation method in this manner, the routes of all the transportation methods are not searched in each network. Rather, only routes of a transportation method corresponding to a selected network are searched. Therefore, the burden on the CPU 54 in the route search processing can be reduced and it becomes easier to search for a route using various methods of transportation. Moreover, the processing speed of the route search processing can be increased.

Since each network data includes the uppermost to lowermost hierarchical layers and layer data on a higher layer is formed by search data of a broader range while layer data on a lower layer is formed by search data of a narrower range, the data quantity of the search data of the broader range and the data quantity of the search data of the narrower range can be made even to a certain extent. Even in the case of searching a broader range, the data quantity of search data as an object of search is not particularly increased. Therefore, the burden the CPU 54 in the route search processing can be reduced and it becomes easier to search for a route. Moreover, the processing speed of the route search processing can be increased.

The flowchart shown in FIG. 10 will now be described.

At step S2-1, a network is selected.

At step S2-2, a layer is selected.

At step S2-3, search processing is performed.

At step S2-4, whether search on the lowermost layer has ended or not is determined. If the search on the lowermost layer has ended, the processing goes to step S2-5. If not, the processing goes back to step S2-2.

At step S2-5, search and judgment processing is performed.

At step S2-6, whether search end judgment processing has been performed or not is determined. If the search end judgment processing has been performed, a return is made. If not, the processing goes back to step S2-1.

While the route search processing, are performed in the information center 51 in this exemplary embodiment, the route search processing, can also be performed in the PDA 14. In this case, as search conditions are set by the search condition setting processing unit of the CPU 31, the information acquisition processing unit 91 of the CPU 31 performs information acquisition processing to refer to the search data base in the data recording unit 16, then search data is read and necessary information for searching a route is acquired.

Next, a route search processing unit (not shown) of the CPU 31 performs route search processing to search for routes on the basis of the search data in accordance with the search conditions, and outputs candidate routes.

Next, the display processing unit of the CPU 31 forms a candidate route display screen on the display unit 35 and displays candidate routes on the candidate route display screen. The audio output processing unit of the CPU 31 outputs the candidate list from the audio output unit 37 in accordance with the audio output data.

In this case, even if the CPU 31 has low processing capabilities, only routes of a method of transportation corresponding to a selected network are searched and the burden on the CPU 31 in the route search processing can be reduced. Therefore, even if the CPU 31 has low processing capabilities, it becomes easier to search for a route and the processing speed of the route search processing can be increased.

While the present disclosure describes certain preferred embodiments for use in Japan, it will be readily apparent to one having ordinary skill in the art that the invention is easily adaptable for use in other countries.

It should be understood that this invention is not limited to these exemplary embodiments and various modifications can be made without departing from the scope of this invention. Such modifications are included in the scope of this invention.

What is claimed is:

1. A navigation system, comprising:
an information acquisition processing unit for acquiring search data, including network data of networks formed for individual transportation measures;
a search processing unit for hierarchical searching of acquired search data for routes based on the network data beginning with a network of a highest priority; and
a route connection processing unit for connecting routes found as a result of the search.

2. The navigation system as claimed in claim 1, wherein each of the network data includes layer data of a plurality of hierarchical layers from a highest layer to a lowest layer, and the search processing unit searches for a route on each layer.

3. The navigation system as claimed in claim 2, wherein layer data on a higher layer is formed by search data of a broader range and layer data on a lower layer is formed by search data of a narrower range.

4. The navigation system as claimed in claim 1, wherein the priority of the networks is set in advance.

5. The navigation system as claimed in claim 1, wherein the priority of the networks can be changed by an operator.

6. A navigation system, comprising:
a network data acquisition processing unit for reading out network data of networks formed for individual methods of transportation beginning with a network of a highest priority;
a search processing unit for searching for routes on each network on the basis of the network data;
a route connection processing unit for connecting the routes found as a result of the search; and
a route guide data transmission processing unit for transmitting route data of the connected routes to a terminal device.

7. A storage medium for storing a set of instructions executable on a data processing device and usable to search for a navigation route causing a computer to function as an information acquisition processing unit, comprising:
instructions for acquiring search data including network data of networks formed for individual transportation measures, respectively;
instructions for searching for routes based on the network data in order from a network of the highest priority, of the acquired search data; and
instructions for connecting routes found as a result of the search.
